(19) United States
(12) Patent Application Publication
(10) Pub. No.: US 2025/0320129 A1
(43) Pub. Date: Oct. 16, 2025

(54) SYSTEM AND METHOD FOR PREPARING BARIUM CARBONATE BY ENHANCING ALKANOLAMINE ABSORPTION AND MINERALIZATION OF CO2

(71) Applicant: North University of China, Taiyuan City (CN)

(72) Inventors: Weizhou JIAO, Taiyuan City (CN); Kangrui NIE, Taiyuan City (CN); Youzhi LIU, Taiyuan City (CN); Chao ZHANG, Taiyuan City (CN); Guisheng QI, Taiyuan City (CN); Jing GAO, Taiyuan City (CN); Zhiguo YUAN, Taiyuan City (CN)

(21) Appl. No.: 19/009,301

(22) Filed: Jan. 3, 2025

(30) Foreign Application Priority Data
Apr. 11, 2024 (CN) 202410432652.6

(51) Int. Cl. C01F 11/18; B01D 53/14; B01D 53/18; B01D 53/62; B01D 53/78; B01J 8/00; B01J 8/02

(52) U.S. Cl. CPC C01F 11/188; B01D 53/1418; B01D 53/1475; B01D 53/1493; B01D 53/185; B01D 53/62; B01D 53/78; B01J 8/001; B01J 8/0278; B01D 2252/20484; B01D 2257/504; B01J 2208/00548; B01J 2208/00938; B01J 2208/00973; B01J 2208/028; C01P 2004/64; C01P 2006/12; C01P 2006/80

(57) ABSTRACT

Provided are a system and method for preparing barium carbonate by enhancing alkanolamine absorption and mineralization of CO2. The system includes a rotating packed bed provided with a first gas inlet, a first exhaust port, a first liquid inlet, and a first liquid outlet. An absorbent barren liquid storage container in communication with the first liquid inlet through a pipeline on which a water pump is arranged. A rich liquid storage container is in communication with the first liquid outlet through a pipeline. A saturated liquid storage container, an ultrasonic mineralization reaction device, and a mineralization feedstock storage container. The saturated liquid storage container is in communication with the rich liquid storage container and the ultrasonic mineralization reactor through a pipeline, respectively. The mineralization feedstock storage container is communicated with the ultrasonic mineralization reaction device through a pipeline on which a feeding blower is arranged.

### CROSS-REFERENCE TO RELATED APPLICATION

This patent application claims the benefit and priority of Chinese Patent Application No. 202410432652.6 filed with the China National Intellectual Property Administration on Apr. 11, 2024, the disclosure of which is incorporated by reference herein in its entirety as part of the present application.

### TECHNICAL FIELD

The present disclosure belongs to the technical field of waste gas treatment equipment, and in particular to a system and method for preparing barium carbonate by enhancing alkanolamine absorption and mineralization of CO₂.

### BACKGROUND

Since the industrial revolution, a large amount of CO₂ emitted by fossil fuel combustion in coal-fired power plants has led to an increasing global greenhouse effect, which has seriously threatened the living environment of human beings and climate change. At present, the capture technology of CO₂ gas mainly includes a chemical absorption method, a physical adsorption method, a membrane absorption separation method, a low-temperature separation method, and so on. Alkanolamine chemical absorption method has gradually become the main technology of CO₂ absorption due to its advantages of mature process, fast absorption rate and low cost.

However, the alkanolamine chemical absorption method for CO₂ has the problem of high regeneration energy consumption by heating and desorption, and most of the equipment in industry is absorption tower, which has the problems of low mass transfer efficiency and huge equipment volume. Therefore, how to reduce the energy consumption in the desorption process and enhance gas-liquid mass transfer is the key to improve and promote the development of CO₂ absorption by alkanolamine.

In the CO₂ mineralization technology, alkaline earth metal rich in calcium, barium and magnesium or alkaline solid wastes are used to carry out mineralization reaction with CO₂ in an industrial flue gas, and CO₂ is permanently stored in the form of solid product carbonate.

At present, the CO₂ absorption-mineralization integrated technology (which combines the alkanolamine chemical absorption method for CO₂ with the CO₂ mineralization technology) uses pH control instead of temperature control to carry out chemical regeneration of alkanolamine and the preparation of carbonate products, which not only significantly reduces the overall energy consumption of the system, but also simplifies the process and reduces the cost, which is beneficial to industrialization and has a wide application prospect. However, at present, the integrated technology for preparing barium carbonate by alkanolamine absorption and resource utilization of CO₂ is limited by the problems of low mass transfer efficiency and huge size of traditional tower equipment, uneven particle size distribution and larger particle size of barium carbonate prepared by the traditional stirred tank reactor, and thus is difficult to achieve efficient capture of CO₂ and ultrafine preparation of the barium carbonate.

### SUMMARY

An objective of an implementation of the present disclosure is to provide a system for preparing barium carbonate by enhancing alkanolamine absorption and mineralization of CO₂, which has the advantages of simple structure, convenient operation, and capability of improving the above problems better.

An objective of an implementation of the present disclosure is to provide a method for preparing barium carbonate by enhancing alkanolamine absorption and mineralization of CO₂, which is simple in process, capable of achieving efficient capture of CO₂ in the waste gas, good in mineralization effect, and low in energy consumption of the process.

An implementation of the present disclosure is achieved as follows:

The implementation of the present disclosure provides a system by enhancing alkanolamine absorption and mineralization of CO₂, including a rotating packed bed, an absorbent barren liquid storage container, a rich liquid storage container, a saturated liquid storage container, an ultrasonic mineralization reaction device, and a mineralization feedstock storage container.

The rotating packed bed is provided with a first gas inlet, a first exhaust port, a first liquid inlet, and a first liquid outlet. The absorbent barren liquid storage container is communicated with the first liquid inlet of the rotating packed bed through a pipeline on which a water pump is arranged; the rich liquid storage container is communicated with the first liquid outlet of the rotating packed bed through a pipeline. The saturated liquid storage container is communicated with the rich liquid storage container and the ultrasonic mineralization reactor through pipelines, respectively. The mineralization feedstock storage container is communicated with the ultrasonic mineralization reaction device through a pipeline on which a feeding blower is arranged.

Further, the rotating packed bed includes a gas-liquid reaction shell, a rotor, a packing module, a liquid distributor, and a driving mechanism. The rotor is rotatably supported in the gas-liquid reaction shell, the packing module is arranged on the rotor, a middle of the rotor is provided with a channel, and the liquid distributor is inserted into the channel of the rotor from a top of the gas-liquid reaction shell. A rotating shaft of the driving mechanism penetrates into the gas-liquid reaction shell from a bottom of the gas-liquid reaction shell, and is connected to the rotor. The first gas inlet is formed in a side wall of the gas-liquid reaction shell, the first exhaust port is formed in the top of the gas-liquid reaction shell, the first liquid inlet is formed in the liquid distributor, and the first liquid outlet is formed in the bottom of the gas-liquid reaction shell. A liquid outlet end of the water pump is communicated with the first liquid inlet in the liquid distributor through a pipeline.

Further, the ultrasonic mineralization reaction device includes an ultrasonic mineralization reaction container, an ultrasonic generator, and an ultrasonic transducer. A second liquid inlet and a solid adding port are formed in a top of the ultrasonic mineralization reaction container, and the ultrasonic mineralization reaction container is provided with a second liquid outlet at a side wall close to a bottom of the ultrasonic mineralization reaction container. The ultrasonic transducer is arranged at the top of the ultrasonic mineralization reaction container, and has one end of the ultrasonic transducer is extended into the ultrasonic mineralization reaction container. The ultrasonic generator is connected to the ultrasonic transducer. The saturated liquid storage container is communicated with the second liquid inlet of the ultrasonic mineralization reaction container through a pipeline, and the mineralization feedstock storage container is communicated with the solid adding port of the ultrasonic mineralization reaction container through a pipeline.

Further, a product slurry collecting tank is connected to the second liquid outlet of the ultrasonic mineralization reaction container through a pipeline, and the bottom of the ultrasonic mineralization reaction container is provided with a lifting table.

Further, the system also includes a drying tank, and a CO₂ concentration infrared detector. The first exhaust port of the rotating packed bed is communicated with a gas inlet end of the drying tank through a pipeline, and a detection probe of the CO₂ concentration infrared detector is arranged at an exhaust end of the drying tank.

Further, a gas inlet control device is arranged at the first gas inlet of the rotating packed bed, and the gas inlet control device includes a gas buffer tank, and a blower. The gas buffer tank is provided with a second gas inlet, a third gas inlet, and a second exhaust port. A CO₂ transport pipe is connected to the second gas inlet of the gas buffer tank, and a first flowmeter is arranged on the CO₂ transport pipe. The blower is communicated with the third gas inlet of the gas buffer tank through a pipeline, the second exhaust port of the gas buffer tank is communicated with the first gas inlet of the rotating packed bed through a pipeline on which a second flowmeter is arranged.

An implementation of the present disclosure provides a method for preparing barium carbonate by enhancing alkanolamine absorption and mineralization of CO₂, including the following steps:
Step 1: transporting an alkanolamine absorbent into a rotating packed bed from a first liquid inlet, and transporting a gas mixture containing CO₂ into the rotating packed bed from a first gas inlet, forming a high-gravity environment when the rotating packed bed works, and sufficiently mixing the gas mixture containing CO₂ and the alkanolamine absorbent for reaction; and when concentrations of CO₂ in a first exhaust port is a same as a concentration of CO₂ in the first gas inlet, stopping gas to supply into the first gas inlet, and stopping liquid to supply into the first liquid inlet;
Step 2: discharging CO₂ saturated absorption liquid from a first liquid outlet into a rich liquid storage container, and then transferring the CO₂ saturated absorption liquid into a saturated liquid storage container; respectively adding the CO₂ saturated absorption liquid in a saturated liquid storage container and a mineralization feedstock in a mineralization feedstock storage container into an ultrasonic mineralization reaction device to react for 5-90 minutes at a certain frequency;
Step 3: after the mineralization reaction is completed, discharging a product into a designated container for solid-liquid separation, transporting liquid into an absorbent barren liquid storage container for recycling, and washing and drying solids to obtain a barium carbonate product.

Further, in Step 1, the alkanolamine absorbent is ethanolamine with a concentration of 7 wt %. A transport rate of ethanolamine is in a range of 20-80 L/h, a transport rate of CO₂ is in a range of 450-470 mL/min, and a high-gravity factor in a high-gravity environment is in a range of 10-40.

Further, in Step 2, the mineralization feedstock is barium hydroxide, the ratio of the CO₂ saturated absorption liquid to the barium hydroxide in amount of substance is in a range of 1: 0.8-1:1.2, and an ultrasonic frequency during mineralization reaction is in a range of 4000-20000 HZ.

Further, in Step S3, after solid-liquid separation, the solid is dried in a drying oven at a temperature of 105° C. for 24 hours to obtain barium carbonate particulate matter which has a particle size of 57.2-89 nm, a content of 99.6%, and a specific surface area of 14.119 m²/g.

The present disclosure has the beneficial effects that:

The system for preparing barium carbonate by enhancing alkanolamine absorption and mineralization of CO₂ provided by the implementation of the present disclosure is convenient for use. The rotating packed bed can efficiently capture CO₂ in the waste gas with the alkanolamine absorbent, and a gas-liquid two-phase fluid has undergone multiple dispersion-aggregation processes in the high-speed rotating packing, which increases the contact area between the gas and liquid phases and improves the interphase transfer efficiency. In addition, in the ultrasonic mineralization reactor, the CO₂ saturated absorption liquid makes a mineralization reaction with barium-based mineralization feedstocks such as barium hydroxide or barium oxide solid. The ultrasonic generator can fully mix the barium hydroxide or barium oxide solid with the CO₂ saturated absorption liquid through an ultrasonic transducer at a certain frequency. Under ultrasonic radiation, the turbulent effect of cavitation enables solid particles and liquid to oscillate and collide at a high speed. The cleaning of a boundary layer and a solid particle surface by the micro-jet and shock waves can form surface eroded spots and boundary layer cavities. The boundary layer of solid particles is thinned, while the diffusion in the boundary layer is strengthened, and the whole liquid-solid mass transfer process is accelerated. In addition, the action of the surface erosion and fragmentation of solid particles as well as the activation and energy gathering effects can accelerate the chemical reaction on the interface, which makes further strengthening effect on the products generated by the mineralization reaction between the CO₂ saturated absorption liquid and barium hydroxide or barium oxide solid, thus enhancing the effect of mineralization and utilization for CO₂.

The method for preparing barium carbonate by enhancing alkanolamine absorption and mineralization of CO₂ is provided in implementations of the present disclosure. According to this method, the process is simple, the capture of CO₂ in waste gas is effective, the reaction rate of CO₂ mineralization and utilization is rapid, the conversion rate of CO₂ is high, the mineralization effect is good, and the energy consumption of the process is low. Finally, a high-purity electronic-grade barium carbonate product can be prepared, and the regenerated CO₂ absorbent barren liquid can be recycled in the production process, thus saving the cost.

### BRIEF DESCRIPTION OF THE DRAWINGS

To describe the technical solutions of the implementations of the present disclosure more clearly, the following briefly introduces the accompanying drawings required for describing the implementations. It should be understood that the accompanying drawings in the following description show merely some implementations of the present disclosure, and thus should not be construed as the limitation of the scope. Those skilled in the art may still derive other relational drawings in accordance with these accompanying drawings without creative efforts.

FIG. 1 is a structural diagram of a system for preparing barium carbonate by enhancing alkanolamine absorption and mineralization of CO₂ according to embodiments of the present invention.

In the drawings: 1—rotating packed bed; 11—gas—liquid reaction shell; 12—rotor; 13—packing module; 14—liquid distributor; 15—driving mechanism; 16—first gas inlet; 17—first exhaust port; 18—first liquid inlet; 19—first liquid outlet; 2—absorbent barren liquid storage container; 21—water pump; 3—rich liquid storage container; 4—saturated liquid storage container; 5—ultrasonic mineralization reaction device; 51—ultrasonic mineralization reaction container; 52—ultrasonic generator; 53—ultrasonic transducer; 54—second liquid inlet; 55—solid adding port; 56—second liquid outlet; 57—product slurry collecting tank; 58—lifting table; 6—mineralization feedstock storage container; 61—feeding blower; 7—gas inlet control device; 71—gas buffer tank; 72—blower; 73—first flowmeter; 74—second flowmeter; 8—drying tank; 81—CO₂ concentration infrared detector.

### DETAILED DESCRIPTION OF THE EMBODIMENTS

To make the objectives, technical solutions and advantages of the present disclosure more clearly, the following clearly and completely describes the technical solutions in the implementations of the present disclosure with reference to the accompanying drawings in the implementations of the present disclosure. Apparently, the described implementations are merely a part rather than all of the implementations of the present disclosure. The assemblies of the implementations of the present disclosure generally described and illustrated in the accompanying drawings herein can be arranged and designed in a variety of different configurations.

It should be noted that the implementations in the present disclosure and the features in the implementations can be combined with each other without conflict.

It should be noted that similar reference numerals and letters refer to similar items in the following figures, and thus once an item is defined in one drawing, it may not be further defined or explained in the following accompanying drawings.

In the description of the present disclosure, it should be noted that orientation or positional relations indicated by terms such as “inside, “outside”, “up”, “down” and the like are based on the orientation or positional relations as shown in the accompanying drawings, or the relations of the orientation or position where the inventive product is conventionally placed when in use, or the orientation or positional relations that are conventionally understanding for those skilled in the art, which is only for facilitating describing the present disclosure and simplifying the description, rather than indicating or implying that the referred devices or elements must be in a particular orientation or constructed or operated in a particular orientation, thus which should not be construed as limiting the present disclosure. In addition, terms such as “first” and “second” are used only for distinguishing description, and should not be understood as indicating or implying relatively importance.

In the description of the present disclosure, it should be also noted that unless otherwise expressly specified or defined, terms “provided”, “mounted”, “connected . . . with”, and “connected” should be understood broadly, and for example, a connection may be a fixed connection, a detachable connection, or an integrated connection; may be a mechanical connection; may be a direct connection, or an indirect connection via an intermediate medium; or may be an internal communication between two elements. The specific meanings of the above terms in the present disclosure can be understood by those skilled in the art according to specific situations.

### Embodiment 1

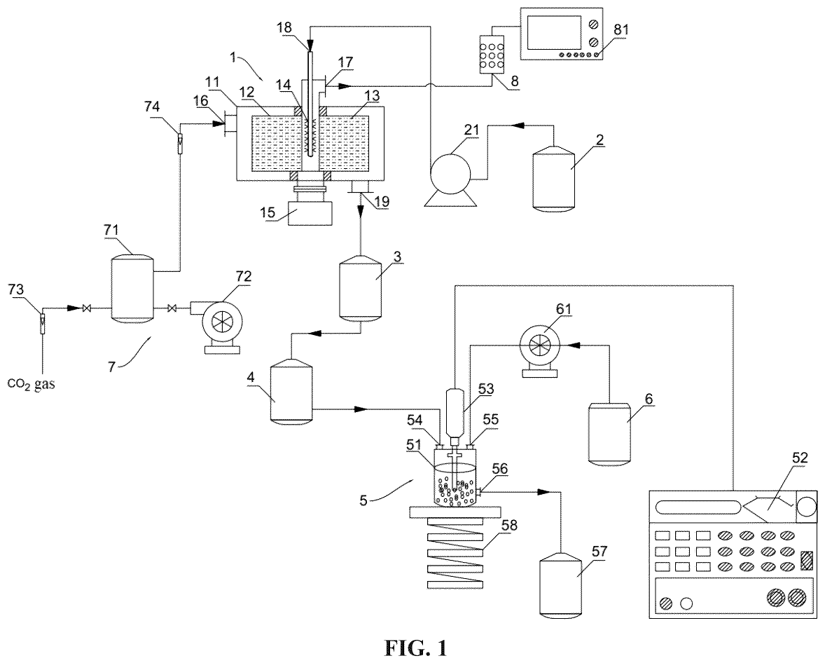

As shown in FIG. 1, a system for preparing barium carbonate by enhancing alkanolamine absorption and mineralization of CO₂ is provided in an embodiment of the present disclosure, and includes a rotating packed bed 1, an absorbent barren liquid storage container 2, a rich liquid storage container 3, a saturated liquid storage container 4, an ultrasonic mineralization reaction device 5, and a mineralization feedstock storage container 6.

The rotating packing bed 1 includes a gas-liquid reaction shell 11, a rotor 12, a packing module 13, a liquid distributor 14, and a driving mechanism 15. The rotor 12 is rotatably supported in the gas-liquid reaction shell 11, the packing module 13 is arranged on the rotor 12, and a channel is arranged in a middle portion of the rotor 12 along an axial direction. The liquid distributor 14 penetrates into the shell from the top of the gas-liquid reaction shell 11, and a lower end of the liquid distributor 14 extends into the channel of the rotor 12. A rotating shaft of the driving mechanism 15 penetrates into the gas-liquid reaction shell 11 from the bottom of the gas-liquid reaction shell 11 and is connected to the rotor 12. The driving mechanism 15 is used to drive the rotor 12 to rotate, and thus a motor can be used to directly drive the rotor 12 to rotate, or the motor can be used to drive the rotor 12 to rotate through a speed reducer. A first gas inlet 16 is formed in a side wall of the gas-liquid reaction shell 11 close to the its top, a first exhaust port 17 is formed in the top of the gas-liquid reaction shell 11, a first liquid inlet 18 is formed in an upper end of the liquid distributor, and a first liquid outlet 19 is formed in the bottom of the gas-liquid reaction shell 11. The absorbent barren liquid storage container 2 is communicated with the first gas inlet 18 on the liquid distributor 14 through a pipeline on which a water pump 21 is arranged. The water pump 21 can transport absorbent barren liquid in the absorbent barren liquid storage container 2 into the liquid distributor 14, and then the liquid distributor 14 can sprays the absorbent barren liquid into the rotor 12.

The first liquid outlet 19 of the gas-liquid reaction shell 11 is communicated with the rich liquid storage container 3 through a pipeline, and the rich liquid storage container 3 is communicated with the saturated liquid storage container 4 through a pipeline.

A gas inlet control device 7 is arranged in front of the first gas inlet 16, which includes a gas buffer tank 71, and a blower 72. The gas buffer tank 71 is provided with a second gas inlet, a third gas inlet, and a second exhaust port. A CO₂ transport pipe is connected to the second gas inlet of the gas buffer tank 71, and a first flowmeter 73 and a valve are arranged on the pipeline. The blower 72 is communicated with the third gas inlet of the gas buffer tank 71 through a pipeline on which a valve is arranged. The second exhaust port of the gas buffer tank 71 is communicated with the first gas inlet 16 on the gas-liquid reaction shell 11 through a pipeline on which a second flowmeter 74 is arranged. In this embodiment, the CO₂ gas is supplied with a CO₂ steel cylinder. Certainly, the CO₂ gas may also be various types of waste gas containing CO₂ that needs to be treated. The CO₂ gas is transported into the gas buffer tank 71, the blower 72 also transports the air into the gas buffer tank 71 to dilute the CO₂ gas, and then the CO₂ gas is transported into the gas-liquid reaction shell 11. In a high-gravity environment, the CO₂ gas is mixed and in contact with the absorbent barren liquid, and the CO₂ gas is absorbed.

The first exhaust port 17 of the gas-liquid reaction shell 11 is connected to a drying tank 8 through a pipeline, and an exhaust end of the drying tank 8 is also provided with a CO₂ concentration infrared detector 81. In this embodiment, a detection probe of the CO₂ concentration infrared detector 81 is arranged at the exhaust end of the drying tank 8. The drying tank 8 is used to dry the gas exhausted from the first exhaust port 17 and then exhaust the dried gas is exhausted to the outside world. The CO₂ concentration infrared detector 81 is used to detect the concentration of CO₂ in the gas exhausted from the drying tank 8, thus determining whether the absorption of the absorbent barren liquid is saturated. When the absorption reaches saturation, the first gas inlet 16 and the first liquid inlet 18 are closed, and the saturated liquid in the gas-liquid reaction shell 11 is discharged into the rich liquid storage container 3 through the first liquid outlet 19, and then the saturated liquid is transferred from the rich liquid storage container 3 to the saturated liquid storage container 4 for temporary storage.

In this embodiment, the ultrasonic mineralization reaction device 5 includes an ultrasonic mineralization reaction container 51, an ultrasonic generator 52, and an ultrasonic transducer 53. A second liquid inlet 54 and a solid adding port 55 are formed in the top of the ultrasonic mineralization reaction container 51, and a second liquid outlet 56 is formed at a side wall of the ultrasonic mineralization reaction container 51 close to its bottom. The ultrasonic transducer 53 is arranged at the top of the ultrasonic mineralization reaction container 51, and one end of the ultrasonic transducer 53 is extended into the ultrasonic mineralization reaction container 51. The ultrasonic generator 52 is connected to the ultrasonic transducer 53. The saturated liquid storage container 4 is communicated with the second liquid inlet 54 of the ultrasonic mineralization reaction container 51 through a pipeline, the mineralization feedstock storage container 6 is communicated with the solid adding port 55 of the ultrasonic mineralization reaction container 51 through a pipeline on which a feeding blower 61 is arranged. A product slurry collecting tank 57 is connected to the second liquid outlet 56 of the ultrasonic mineralization reaction container 51 through a pipeline. The liquid in the saturated liquid storage container 4 is transported into the ultrasonic mineralization reaction container 51, and the mineralization feedstock in the mineralization feedstock storage container 6 is also added into the ultrasonic mineralization reaction container 51 through the feeding blower 61. Then, the ultrasonic generator 52 makes the mineralization feedstock react with the saturated liquid containing CO₂ through the ultrasonic transducer 53 at a certain frequency. After the reaction is completed, the solution is discharged into the product slurry collecting tank 57 for solid-liquid separation, the liquid is recycled, and the solid is washed and dried to obtain a required product.

A lifting table 58 is arranged at the bottom of the ultrasonic mineralization reaction container 51, which is convenient to adjust the height of the ultrasonic mineralization reaction container 51.

### Embodiment 2

A method for preparing barium carbonate by enhancing alkanolamine absorption and mineralization technology of CO₂ is provided in the embodiment 2 of the present disclosure, which includes the following steps:

Step 1, an alkanolamine absorbent is transported into a rotating packed bed 1 from a first liquid inlet 18, and meanwhile, a gas mixture containing CO₂ is transported into the rotating packed bed 1 from a first gas inlet 16. A high-gravity environment is formed when the rotating packed bed 1 works, the gas mixture containing CO₂ collides with the alkanolamine absorbent in the high-speed rotating packing module 13 to fully mix for reaction, and the CO₂ in the gas mixture is absorbed by the alkanolamine absorbent. When the concentration of CO₂ in a first exhaust port 17 is same as that in the first gas inlet 16, gas is stopped to supply into the first gas inlet 16, and liquid is stopped to supply into the first liquid inlet 18.

In this step, the alkanolamine absorbent is ethanolamine with a concentration of 7 wt %. A transport rate of the ethanolamine is in a range of 20-80 L/h, a transport rate of CO₂ is in a range of 450-470 mL/min, and a high-gravity factor in the high-gravity environment is in a range of 10-40.

Step 2, CO₂ saturated absorption liquid is discharged from a first liquid outlet 19 into a rich liquid storage container 3, and then the CO₂ saturated absorption liquid is transferred into a saturated liquid storage container 4. The CO₂ saturated absorption liquid in the saturated liquid storage container 4 and mineralization feedstock in a mineralization feedstock storage container 6 are respectively added into an ultrasonic mineralization reaction device 5 to react for 5-90 minutes at a certain frequency.

In this step, the mineralization feedstock is barium hydroxide or barium oxide, the ratio of CO₂ saturated absorption liquid to the barium hydroxide in amount of substance is in a range of 1:0.8-1:1.2, and an ultrasonic frequency during mineralization reaction is in a range of 4000-20000 HZ, preferably 10000 HZ in this embodiment. Under ultrasonic radiation, the turbulent effect of cavitation enables solid particles and liquid to oscillate and collide at a high speed. The cleaning of a boundary layer and a solid particle surface by the micro-jet and shock waves can form surface eroded spots and boundary layer cavities. The boundary layer of solid particles is thinned, while the diffusion in the boundary layer is strengthened, and the whole liquid-solid mass transfer process is accelerated. In addition, the action of the surface erosion and fragmentation of solid particles as well as the activation and energy gathering effects can accelerate the chemical reaction on the interface, which makes further strengthening effect on the products generated by the mineralization reaction between the CO₂ saturated absorption liquid and barium hydroxide or barium oxide solid.

Step 3, After the mineralization reaction is completed, the product is discharged into a designated container for solid-liquid separation, the liquid is transported into an absorbent barren liquid storage container 2 for recycling, and the solid is washed and dried to obtain barium carbonate product.

In this step, after solid-liquid separation, the solid is dried in a drying oven at a temperature of 105° C. for 24 hours to obtain barium carbonate particulate matter which has a particle size of 57.2-89 nm, a content of 99.6%, and a specific surface area of 14.119 m²/g.

According to the industrial standard HG/T 4695-2014 High purity barium carbonate for industrial use and the enterprise standard Q/0521DCX003-2021 Optoelectronic-grade barium carbonate, it is proved that the barium carbonate has different application potentials in glass substrates, medium and high voltage ceramic capacitors, semiconductor capacitors, other barium salts, luminescent materials, water purifiers, magnetic materials and other industrial fields, and meets the quality requirements of high-purity electronic-grade barium carbonate.

The present disclosure is not limited to the above alternative implementations, and any person can obtain other products in various forms under the inspiration of the present disclosure. No matter any change made in the shape or structure of the products, all technical solutions falling within the scope defined in claims of the present disclosure fall within the scope of protection of the present disclosure.

What is claimed is:

1. A system for preparing barium carbonate by enhancing alkanolamine absorption and mineralization of CO₂, comprising:
a rotating packed bed having a first gas inlet, a first exhaust port, a first liquid inlet, and a first liquid outlet;
an absorbent barren liquid storage container in communication with the first liquid inlet through a pipeline on which a water pump is arranged;
a rich liquid storage container in communication with the first liquid outlet of the rotating packet bed through a pipeline;
a saturated liquid storage container,
an ultrasonic mineralization reaction device, and
a mineralization feedstock storage container in communication with the ultrasonic mineralization reaction device through a pipeline on which a feeding blower is arranged;
wherein the saturated liquid storage container is communicated with the rich liquid storage container and the ultrasonic mineralization reactor through additional pipelines, respectively.

2. The system for preparing barium carbonate by enhancing alkanolamine absorption and mineralization of CO₂ according to claim 1, wherein the rotating packed bed comprises:
a gas-liquid reaction shell having a first gas inlet formed in a side wall thereof, a first exhaust port formed in a top thereof and a first liquid outlet formed in bottom thereof;
a rotor rotatably supported in the gas-liquid reaction shell and having a channel provided at a middle thereof,
a packing module arranged on the rotor,
a liquid distributor inserted into the channel of the rotor from a top of the gas-liquid reaction shell, the liquid distributor having a first liquid inlet in communication with a liquid outlet end of a water pump through a pipeline; and
a driving mechanism having a rotating shaft connected to the rotor, the rotating shaft penetrates into the gas-liquid reaction shell from a bottom of the gas-liquid reaction shell.

3. The system for preparing barium carbonate by enhancing alkanolamine absorption and mineralization of CO₂ according to claim 1, wherein the ultrasonic mineralization reaction device comprises:
an ultrasonic mineralization reaction container having a second liquid inlet and a solid adding port formed in a top thereof and a second liquid outlet at a side wall close to a bottom thereof;
an ultrasonic transducer arranged at the top of the ultrasonic mineralization reaction container where one end of the ultrasonic transduce extends into the ultrasonic mineralization reaction container; and
an ultrasonic generator connected to the ultrasonic transducer;
wherein the saturated liquid storage container is in communication with the second liquid inlet of the ultrasonic mineralization reaction container through a pipeline, and the mineralization feedstock storage container is in communication with the solid adding port of the ultrasonic mineralization reaction container through a pipeline.

4. The system for preparing barium carbonate by enhancing alkanolamine absorption and mineralization of CO₂ according to claim 1, wherein a product slurry collecting tank is connected to the second liquid outlet of the ultrasonic mineralization reaction container through a pipeline, and the bottom of the ultrasonic mineralization reaction container is provided with a lifting table.

5. The system for preparing barium carbonate by enhancing alkanolamine absorption and mineralization of CO₂ according to claim 1, further comprising:
a drying tank, and
a CO₂ concentration infrared detector,
wherein the first exhaust port of the rotating packed bed is in communication with a gas inlet end of the drying tank through a pipeline, and a detection probe of the CO₂ concentration infrared detector is arranged at an exhaust end of the drying tank.

6. The system for preparing barium carbonate by enhancing alkanolamine absorption and mineralization of CO₂ according to claim 1, wherein a gas inlet control device is arranged at the first gas inlet of the rotating packed bed, the gas inlet control device comprises a gas buffer tank, and a blower,
the gas buffer tank is provided with a second gas inlet, a third gas inlet, and a second exhaust port;
a CO₂ transport pipe is connected to the second gas inlet of the gas buffer tank, and a first flowmeter is arranged on the CO₂ transport pipe;
the blower is in communication with the third gas inlet of the gas buffer tank through a pipeline, and the second exhaust port of the gas buffer tank is in communication with the first gas inlet of the rotating packed bed through a pipeline on which a second flowmeter is arranged on the pipeline.

7. A method for preparing barium carbonate by enhancing alkanolamine absorption and mineralization of CO₂, wherein the method comprising:
step 1: transporting an alkanolamine absorbent into a rotating packed bed from a first liquid inlet, and transporting a gas mixture containing CO₂ into the rotating packed bed from a first gas inlet, forming a high-gravity environment when the rotating packed bed works, and sufficiently mixing the gas mixture containing CO₂ and the alkanolamine absorbent for reaction; and when a concentration of CO₂ in a first exhaust port is same as a concentration of CO₂ in the first gas inlet, stopping gas to supply into the first gas inlet, and stopping liquid to supply into the first liquid inlet;
step 2: discharging CO₂ saturated absorption liquid from a first liquid outlet into a rich liquid storage container, and then transferring the CO₂ saturated absorption liquid into a saturated liquid storage container; respectively adding the CO₂ saturated absorption liquid in the saturated liquid storage container and a mineralization feedstock in a mineralization feedstock storage container into an ultrasonic mineralization reaction device to react for 5-90 minutes at a certain frequency;
step 3: after the mineralization reaction is completed, discharging a product into a designated container for solid-liquid separation, transporting liquid into an absorbent barren liquid storage container for recycling, and washing and drying solids to obtain a barium carbonate product.

8. The method for preparing barium carbonate by enhancing alkanolamine absorption and mineralization of CO₂ according to claim 7, wherein in step 1, the alkanolamine absorbent is ethanolamine with a concentration of 7 wt %; and a transport rate of ethanolamine is in a range of 20-80 L/h, a transport rate of CO₂ is in a range of 450-470 mL/min, and a high-gravity factor in a high-gravity environment is in a range of 10-40.

9. The method for preparing barium carbonate by enhancing alkanolamine absorption and mineralization of CO₂ according to claim 7, wherein in step 2, the mineralization feedstock is barium hydroxide, the ratio of the CO₂ saturated absorption liquid to the barium hydroxide in amount of substance is in a range of 1:0.8-1:1.2, and an ultrasonic frequency during mineralization reaction is in a range of 4000-20000 HZ.

10. The method for preparing barium carbonate by enhancing alkanolamine absorption and mineralization of CO₂ according to claim 7, wherein in step 3, after solid-liquid separation, the solid is dried in a drying oven at a temperature of 105° C. for 24 hours to obtain barium carbonate particulate matter which has a particle size of 57.2-89 nm, a content of 99.6%, and a specific surface area of 14.119 m²/g.
